(19) United States
(12) Patent Application Publication
(10) Pub. No.: US 2010/0277710 A1
(43) Pub. Date: Nov. 4, 2010

(54) EXPOSURE APPARATUS

(75) Inventor: Shinichi Egashira, Utsunomiya-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/768,484

(22) Filed: Apr. 27, 2010

(30) Foreign Application Priority Data
Apr. 30, 2009 (JP) 2009-111122

(51) Int. Cl. G03B 27/32; G01B 11/14

(52) U.S. Cl. 355/77; 356/620

(57) ABSTRACT

An apparatus includes a measurement station configured to perform a measurement including a reference mark measurement in which a position of a reference mark provided on a stage that supports a substrate is measured, an alignment measurement, and a focus measurement, and an exposure station configured to perform exposure of the substrate by using a result of the measurement, wherein the apparatus performs the measurement of (N+1)th substrate in parallel with exposure of the Nth substrate wherein N is a natural number, and wherein, when time taken to perform the exposure of the Nth substrate is longer than time taken to perform the measurement of (N+1)th substrate in parallel with the exposure, the apparatus performs again the reference mark measurement.

### BACKGROUND OF THE INVENTION

1. Field of the Invention

The present invention relates to a twin-stage type exposure apparatus including an exposure station and a measurement station.

2. Description of the Related Art

When producing devices using a photolithography technique, conventionally, projection exposure apparatuses, which transfer a pattern by projecting the pattern depicted on a reticle onto a wafer or the like by using a projection optical system, have been used. The devices to be produced include a semiconductor device, a liquid crystal display device, a thin film magnetic head, and the like.

The projection exposure apparatus is required to perform projection exposure of a reticle pattern onto a wafer in higher resolution as integrated circuits become more minute and higher density. A minimum line width (resolution) that can be transferred by the projection exposure apparatus is proportional to the wavelength of light used for exposure, and inversely proportional to a numerical aperture (NA) of the projection optical system. Therefore, the shorter the wavelength of light is, the higher the resolution is.

As the wavelength of exposure light becomes short, alignment of wafer is required to be more accurate. Generally, when measuring alignment of wafer, a method called “global alignment” is used in which a shot arrangement on a wafer is measured by measuring several alignment marks and statistically processing the alignment marks.

In an alignment of this global alignment method, although alignment accuracy is expected to increase by increasing the number of measuring points of wafer alignment marks, this decreases throughput because measurement time increases.

Therefore, in recent years, to satisfy the two requirements, which are improvement of alignment accuracy and improvement of throughput, twin-stage type exposure apparatuses including two stages for holding a wafer have appeared as discussed in Japanese Patent Application Laid-Open No. 2008-130621. The twin-stage type exposure apparatus includes an exposure station on which a wafer is actually exposed and a measurement station on which the position of the exposure area of the wafer is measured. Therefore, while performing exposure processing of a first wafer on the exposure station, measurement processing of a second wafer can be performed on the measurement station.

Therefore, the throughput of wafer processing increases, and the apparatus becomes more efficient. In order to use a measurement result of the measurement station in the exposure station, each stage has a position adjustment mark (stage reference mark) for calibration, and a positional relationship between the stations is guaranteed by measuring the reference mark on the stages.

In a conventional twin-stage type exposure apparatus, when the processing time is different between the exposure station and the measurement station, one station waits until the processing of the other station ends. In a twin-stage type exposure apparatus, generally, measurement condition is set so that the processing times of the exposure station and the measurement station are the same. However, when an exposure condition or a measurement condition is changed due to some effect of a user's manufacturing process or the like, the processing times cannot be adjusted to be the same.

When a waiting time occurs in the measurement station, a waiting time occurs from when the stage reference mark is measured in the measurement station to when the stage moves to the exposure station. Therefore, when there is a time-dependent change between the measurement result of the stage reference mark and an actual position of the stage reference mark, an error occurs in the measurement of the stage reference mark. As a result, alignment accuracy decreases compared with a case in which the waiting time does not occur.

### SUMMARY OF THE INVENTION

According to an aspect of the present invention, an apparatus includes a measurement station configured to perform a measurement including a reference mark measurement in which a position of a reference mark provided on a stage supporting a substrate is measured, an alignment measurement, and a focus measurement, and an exposure station configured to perform an exposure of the substrate by using a result of the measurement, wherein the apparatus performs the measurement of (N+1)th substrate in parallel with exposure of the Nth substrate where N is a natural number, and when time taken to perform the exposure of the Nth substrate is longer than time taken to perform the measurement of (N+1)th substrate in parallel with the exposure, the apparatus performs again the reference mark measurement.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a schematic configuration of a twin-stage type exposure apparatus according to a first exemplary embodiment.

FIG. 2 illustrates a configuration of a stage reference plate applied to the apparatus of the first exemplary embodiment.

FIG. 3 illustrates a flowchart of each station according to the first exemplary embodiment.

FIG. 4 illustrates a flowchart of each station according to the first exemplary embodiment.

FIG. 5 is a flowchart illustrating a determination flow of a stage reference mark measurement value according to the first exemplary embodiment.

FIG. 6 illustrates a flowchart of each station according to a second exemplary embodiment.

FIG. 7 illustrates a flowchart of each station according to the second exemplary embodiment.

FIG. 8 is a graph illustrating a relationship between the stage reference mark measurement value and time according to a third exemplary embodiment.

### DESCRIPTION OF THE EMBODIMENTS

Various exemplary embodiments, features, and aspects of the invention will be described in detail below with reference to the drawings.

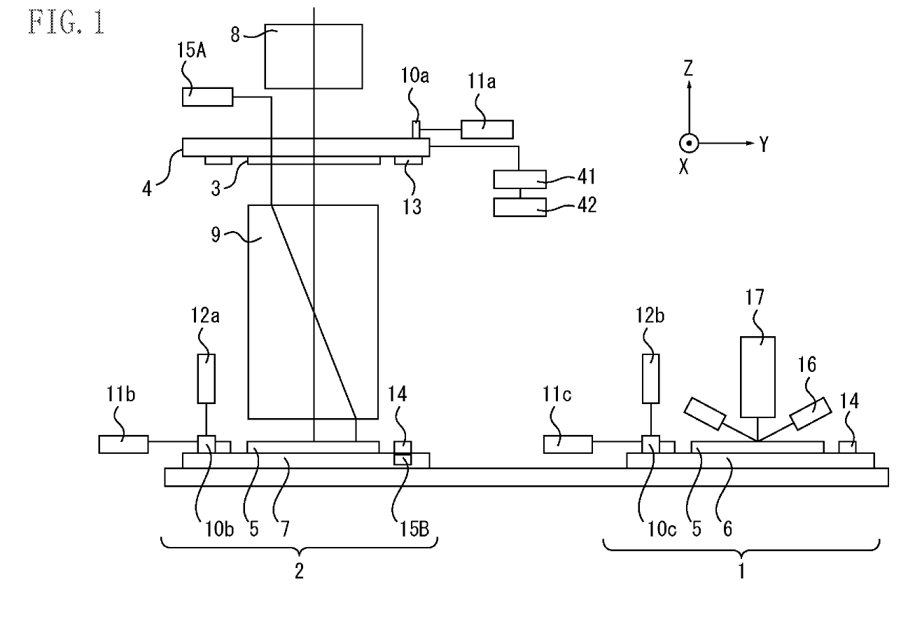

FIG. 1 illustrates a schematic configuration of a twin-stage type exposure apparatus according to a first exemplary embodiment. For example, as illustrated in FIG. 1, the twin-stage type exposure apparatus is an exposure apparatus having two stations, which are a measurement station 1 and an exposure station 2, on a single base.

In the measurement station 1, measurements of shot arrangement, surface irregularity, and the like of a wafer 5 (i.e., substrate) are performed, and in the exposure station 2, exposure processing of the wafer 5 is performed. The surface of the wafer 5 is coated with a photosensitive material.

As illustrated in FIG. 1, the exposure station 2 includes a reticle stage 4, which supports a reticle 3, and two wafer stages 6 and 7, which support the wafer 5 and can move between the two stations. The twin-stage type exposure apparatus includes an illumination optical system 8, which illuminates the reticle 3 supported by the reticle stage 4 with exposure light.

The twin-stage type exposure apparatus further includes a projection optical system 9 for projecting a pattern of the reticle 3 illuminated with the exposure light onto the wafer 5, which is supported by the wafer stages 6 and 7, to expose the wafer 5 to the projected pattern, and a control apparatus 41, which integrally controls an operation of the entire exposure apparatus. Although the two wafer stages 6 and 7 are illustrated in FIG. 1, the exposure apparatus may include three or more wafer stages.

Here, as an twin-stage type exposure apparatus, a scanning type exposure apparatus will be illustrated in which the reticle 3 and the wafer 5 are moved in synchronization with each other and a pattern formed on the reticle 3 is projected onto the wafer 5.

Hereinafter, a direction corresponding to the optical axis in the projection optical system 9 is defined as a Z axis direction, a synchronized movement direction (scanning direction) of the reticle 3 and the wafer 5 in a plane perpendicular to the Z axis direction is defined as a Y axis direction, and a direction (non-scanning direction) perpendicular to the Z axis direction and the Y axis direction is defined as an X direction. Directions going around the X axis, Y axis, and Z axis are defined as a θX direction, a θY direction, and a θZ direction, respectively.

A predetermined illumination area on the reticle 3 is illuminated by the illumination optical system 8 with exposure light having a uniform illuminance distribution. As the exposure light emitted from the illumination optical system 8, a KrF excimer laser and an ArF excimer laser are often used instead of a mercury lamp, which has been the mainstream. Further, to produce higher density semiconductor devices or the like, an exposure apparatus using extreme ultraviolet rays (EUV rays) having a wavelength of several nanometers to 100 nm as exposure light is just being developed. The twin-stage type exposure apparatus of the first exemplary embodiment can be applied to such an exposure apparatus.

The reticle stage 4 supports the reticle 3, can move two-dimensionally in a plane, i.e., the XY plane, perpendicular to the optical axis of the projection optical system 9, and can minutely rotate in the θZ direction. The reticle stage 4 may be at least one-axis driven, and may be six-axis driven. The reticle stage 4 is driven by a reticle stage drive apparatus (not illustrated) such as a linear motor, and the reticle stage drive apparatus is controlled by the control apparatus 41.

A mirror 10a is provided on the reticle stage 4, and a laser interferometer 11a is provided in a position facing the mirror 10a. A two-dimensional position and a rotation angle of the reticle 3 on the reticle stage 4 is measured in real time by the laser interferometer 11a, and the measurement result is output to the control apparatus 41. The control apparatus 41 performs positioning control of the reticle 3 supported by the reticle stage 4 based on the measurement result by the laser interferometer 11a.

The projection optical system 9 projects the pattern of the reticle 3 onto the wafer 5 to expose thereof at a predetermined projection magnification β. The projection optical system 9 includes a plurality of optical elements, and the optical elements are supported by a lens barrel as a metal member. In the first exemplary embodiment, the projection optical system 9 is a reduction projection system having a projection magnification β of, for example, ¼ or ⅕.

The wafer stages 6 and 7 support the wafer 5, and include a Z stage for supporting a wafer chuck, an XY stage for supporting the Z stage, and a base for supporting the XY stage. Hereinafter, these are collectively referred to as XYZ stage.

The wafer stages 6 and 7 are driven by a wafer stage drive apparatus (not illustrated) such as a linear motor. The drive of each wafer stage drive apparatus is controlled by the control apparatus 41. Mirrors 10b and 10c, which move along with the wafer stages 6 and 7, are provided on the wafer stages 6 and 7, and laser interferometers 11b, 11c, 12a, and 12b are provided in a position facing the mirrors 10b and 10c.

The XY direction position and the θZ position of the wafer stages 6 and 7 are measured in real time by the laser interferometers 11b and 11c, and the measurement result is output to the control apparatus 41. The Z direction position and the θX, θY positions of the wafer stages 6 and 7 are measured in real time by the laser interferometers 12a and 12b, and the measurement result is output to the control apparatus 41.

When driving the XYZ stage through the wafer stage drive apparatus based on the measurement results of the laser interferometers 11b, 11c, 12a, and 12b, it is possible to adjust the position of the wafer 5 in the XYZ directions and perform positioning of the wafer 5 on the wafer stages 6 and 7.

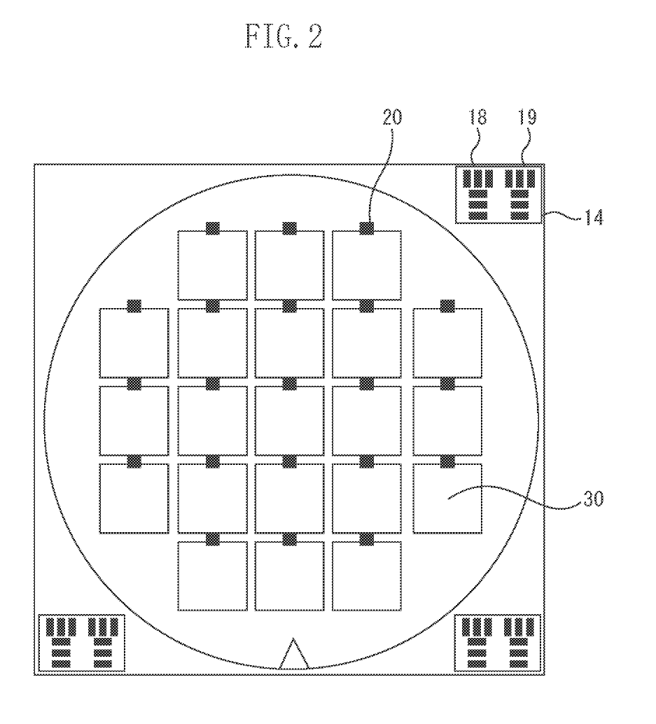

A reticle alignment detection system 15A, which detects a stage reference plate 14 on the wafer stages 6 and 7 through the reticle reference mark 13 on the reticle stage 4 and the projection optical system 9, is provided near the reticle stage 4. The reticle alignment detection system 15A illuminates the reticle reference mark 13 and a reticle alignment detection system reference mark 19 illustrated in FIG. 2 through the projection optical system 9 by using the same light source as that which actually exposes the wafer 5. The reticle reference mark 13 and the reticle alignment detection system reference mark 19 are also used as a positioning mark of the wafer 5.

The reticle alignment detection system 15A emits light and then detects reflected light thereof. The reticle alignment detection system 15A includes, for example, a charge-coupled device (CCD) camera mounted thereon as a photoelectric conversion element. A signal from the photoelectric conversion element is transmitted to the control apparatus 41 and position adjustment of the reticle 3 and the wafer 5 is performed.

When performing the position adjustment of the reticle 3 and the wafer 5, the reticle alignment detection system 15A adjusts positions and focuses of the reticle reference mark 3 and the reticle alignment detection system reference mark 19. As a result, it is possible to perform position adjustment of the reticle 3, the optical axis of the projection optical system 9, and the wafer stages 6 and 7.

The reticle alignment detection system reference mark 19 detected by the reticle alignment detection system 15A is a reflection-type mark. It is also possible to use a transmission-type reticle alignment detection system reference mark 19, and detect the mark by using a transmission-type reticle alignment detection system 15B.

The transmission-type reticle alignment detection system 15B includes a light amount sensor or the like for detecting an amount of transmission light of the reticle reference mark 13 and the transmission-type reticle alignment detection system reference mark 19. By using the same light source as that which actually illuminates the wafer 5 and the illumination optical system 8, the reticle reference mark 13 is illuminated and the reticle alignment detection system reference mark 19 is illuminated through the projection optical system 9, and the amount of transmission light is detected by the transmission-type reticle alignment detection system 15B.

When detecting the amount of transmission light, for example, the transmission-type reticle alignment detection system 15B drives the wafer stage 7 in the X direction or the Y direction, and the Z direction by using the wafer stage drive apparatus controlled by the control apparatus 41, and searches a point at which the amount of transmission light becomes maximum. The transmission-type reticle alignment detection system 15B detects the maximum amount of transmission light, and transmits the information thereof to the control apparatus 41, so that it is possible to adjust the positions and focuses of the reticle reference mark 13 and the reticle alignment detection system reference mark 19.

As a result, also by using the transmission-type reticle alignment detection system 15B, it is possible to perform position adjustment of the reticle 3, the optical axis of the projection optical system 9, and the wafer stages 6 and 7. In this way, any one of the reticle alignment detection system 15A and the transmission-type reticle alignment detection system 15B can be used to perform position adjustment of the reticle 3, the optical axis of the projection optical system 9, and the wafer stages 6 and 7.

FIG. 2 illustrates a configuration of a stage reference plate 14 provided on the wafer stages 6 and 7. The stage reference plate 14 provided at a corner of the wafer stages 6 and 7 is positioned at approximately the same height as the surface of the wafer 5, and includes a wafer alignment detection system reference mark 18 and the reticle alignment detection system reference mark 19.

The wafer alignment detection system reference mark 18 is one of the positioning marks of the wafer 5 to be detected by an alignment detection system 17. On the other hand, the reticle alignment detection system reference mark 19 is a mark to be detected by the reticle alignment detection system 15A or the transmission-type reticle alignment detection system 15B.

The stage reference plate 14 may be arranged at a plurality of corners of the wafer stages 6 and 7, and a single stage reference plate 14 may include a plurality of the wafer alignment detection system reference marks 18 and the reticle alignment detection system reference marks 19.

The positional relationship (in the XY direction) between the wafer alignment detection system reference mark 18 and the reticle alignment detection system reference mark 19 is a predetermined known relationship, and the wafer alignment detection system reference mark 18 and the reticle alignment detection system reference mark 19 may be the shared mark and may have an arbitrary shape.

The measurement station 1 includes a focus detection system 16. The focus detection system 16 includes a projection system for projecting a detection light on the surface of the wafer 5, and a light receiving system (light receiving element) for receiving a reflection light from the wafer 5. The detection result of the focus detection system 16 is output to the control apparatus 41. The focus detection system 16 is constituted separately from the reticle alignment detection system 15A and the transmission-type reticle alignment detection system 15B, and measures the height and the shape of the wafer 5 in advance.

The control apparatus 41 can drive the Z stage based on the detection result of the focus detection system 16, and adjust the position in the Z axis direction and the inclination angle of the wafer 5 supported by the Z stage. The alignment detection system 17 is a detection system for measuring the position of the wafer 5, and detects the position of the wafer 5 by detecting the wafer alignment detection system reference mark 18 and the wafer alignment mark 20 illustrated in FIG. 2.

The wafer alignment detection system reference mark 18 and the wafer alignment mark 20 are a positioning mark of the wafer 5. By transmitting the measurement result to the control apparatus 41, the alignment detection system 17 can also adjust the position of the wafer 5 to a normal position through driving the wafer stage drive apparatus.

Hereinafter, a procedure of focus measurement of the twin-stage type exposure apparatus will be described.

First, in the measurement station 1, the focus detection system 16 focuses on the stage reference plate 14, which is a base reference, and performs focus mapping of the wafer 5. When the focus mapping is performed by the focus detection system 16, the control apparatus 41 detects surface irregularity of the wafer 5 as a difference from the stage reference plate 14 measured as described above, and sequentially stores the differences to a storage unit 42.

The control apparatus 41 and the storage unit 42 may be constituted by an embedded system, or may be substituted by a computer connected to the twin-stage type exposure apparatus of the present exemplary embodiment.

On the other hand, while the focus mapping is being performed, the Z direction laser interferometer 12b continuously measures the mirror 10c, and controls the position of the wafer stage 6 so that the distance is constant.

Next, the wafer stage 6 is moved to the exposure station 2 to expose the wafer 5, which is measured in the measurement station 1. In the exposure station 2, first, by detecting the reticle alignment detection system reference mark 19 by using the reticle alignment detection system 15A, a focal plane of the projection optical system 9 is adjusted to the stage reference plate 14.

Then, by moving the wafer stage 6 based on the difference between the stage reference plate 14 and the surface irregularity of the wafer 5, which is stored in the measurement station 1, the focal plane of the projection optical system 9 is adjusted to the surface of the wafer 5. After adjusting the focal plane of the projection optical system 9 to the surface of the wafer 5, exposure processing in which the pattern of the reticle 3 is transferred to the wafer 5 is performed.

When detecting the reticle alignment detection system reference mark 19 for positioning the stage reference plate 14 to the focal plane of the projection optical system 9 in the exposure station 2, the transmission-type reticle alignment detection system 15B may be used.

In such a twin-stage type exposure apparatus, for example, while performing exposure professing of Nth wafer 5 on the wafer stage 7 in the exposure station 2, exchange and measurement processing of (N+1)th wafer 5 on the wafer stage 6 is performed in the measurement station 1.

When the above operations are completed, the wafer stage 7 moves to the measurement station 1, and at the same time, the wafer stage 6 moves to the exposure station 2. Then, the above described measurement processing and wafer exchange processing are performed on the wafer stage 7, and exposure processing is performed on the (N+1) th wafer 5 on the wafer stage 6 is performed.

In this way, the wafer stages 6 and 7 can be exchanged between the exposure station 2 and the measurement station 1. Although, in FIG. 1, the wafer stage 6 is in the measurement station 2 and the wafer stage 7 is in the exposure station 1, the opposite is possible.

Hereinafter, a procedure of the measurement performed in the twin-stage type exposure apparatus will be described.

First, after the wafer 5 is moved in the measurement station 1, the wafer alignment detection system reference mark 18 is detected by the alignment detection system 17. The focus detection system 16 is constituted separately from the alignment detection system 17, and measures the height and shape of the wafer 5 (i.e., substrate) in advance of the exposure.

Next, a global alignment (alignment measurement) in which a shot arrangement on the wafer in the measurement station 1 is measured is performed. A plurality of wafer alignment marks 20 of the wafer 5, which are positioning marks arranged around the shot areas 30, are measured by the alignment detection system 17.

Based on the measurement result, the control apparatus 41 obtains distances from the wafer alignment detection system reference mark 18 to the wafer alignment marks 20, and statistically estimates coordinates (shot coordinates) of the shot areas illustrated in FIG. 2. The details of the global alignment are discussed in Japanese Patent Application Laid-Open No. 63-232321, so that description thereof will not be repeated in the present exemplary embodiment.

At this time, the larger the number of the measurement points of the wafer alignment mark 20 is, the higher the estimation accuracy of the shot coordinates is, and also the higher the measurement accuracy of one measurement point is, the higher the estimation accuracy of the shot coordinates is. The higher the estimation accuracy of the shot coordinates is, the higher the overlapping accuracy between the position of the reticle 3 and the position of the wafer 5 when performing exposure processing on the wafer 5 is.

When the measurement in the measurement station 1 ends, the wafer stage 6 in the measurement station 1 is moved to the exposure station 2. After the wafer stage 6 is moved to the exposure station 2, first, the wafer alignment detection system reference mark 18 detected by the alignment detection system 17 in the measurement station 1 is detected by the exposure light.

That is, the reticle alignment detection system reference mark 19 is detected by the exposure light by using the reticle alignment detection system 15A or the transmission-type reticle alignment detection system 15B. Based on the detected position of the reticle alignment detection system reference mark 19, the wafer stage 6 is moved to the coordinates of the shot area 30 statistically obtained in the global alignment, and exposure of the shot area 30 illustrated in FIG. 2 is started.

As described above, in the twin-stage type exposure apparatus, the exposure processing in the exposure station and the wafer alignment processing in the measurement station are performed in parallel, so that the throughput higher than that of a conventional exposure apparatus is realized. Therefore, if it takes a long time to perform processing in one station, a waiting time occurs in the processing in the other station.

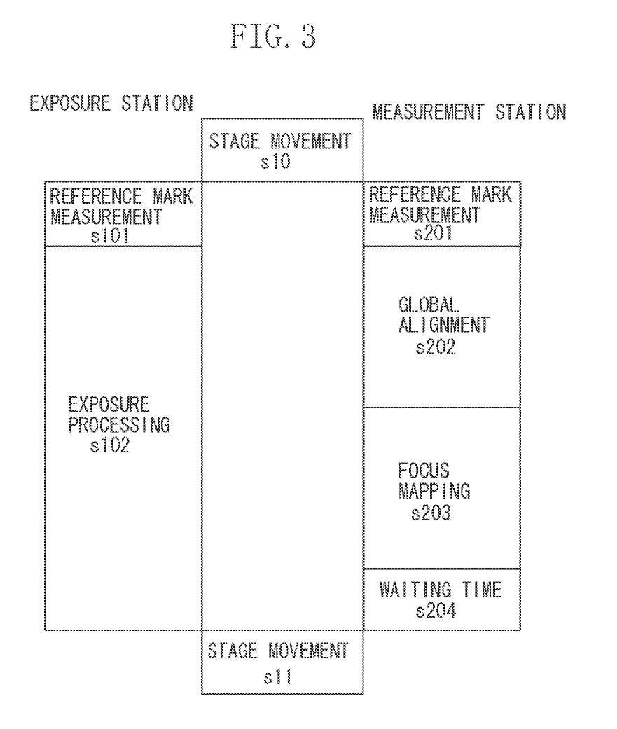

FIG. 3 illustrates a flow in each station when a waiting time occurs in the measurement station. FIG. 3 illustrates only the processing related to the features of the present invention.

After the stage movement s10, in the measurement station 1, “measurement of the wafer alignment detection system reference mark 18 (reference mark measurement)” s201, the global alignment s202, and the focus mapping s203 are sequentially performed. However, when the processing time of the measurement station is shorter than the processing time of the exposure station, the waiting time s204 occurs, and the measurement station waits until the reference mark measurement s101 and the exposure processing s102 are completed in the exposure station.

When the waiting time s204 occurs, if there is a time-dependent change in the measurement result of the reference mark measurement s201, there will be an error between the actual position of the reference mark and the result of the reference mark measurement s201. When there is an error in the reference mark measurement in the measurement station, there will also be an error in the distance between the reference mark and the wafer alignment mark. As a result, a wafer alignment error occurs when performing exposure processing in the exposure station.

Therefore, in the present exemplary embodiment, while the exposure processing is being performed in the exposure station, if the waiting time s204 occurs in the measurement station that has performed the measurement in parallel with the exposure processing, the reference mark measurement is performed again during the waiting time to reduce the error due to the time-dependent change in the result of the reference mark measurement.

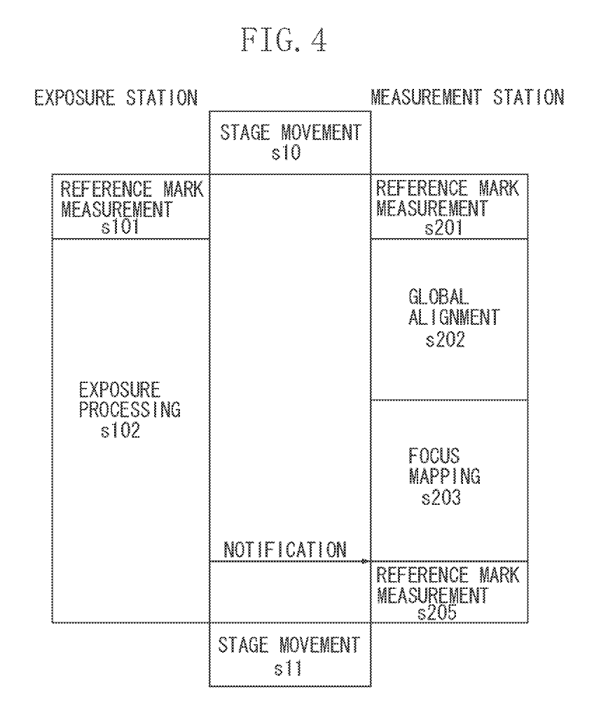

FIG. 4 illustrates a flowchart when the reference mark measurement is performed again. In FIG. 4, the reference mark measurement s205 is performed during the waiting time s204 in FIG. 3. Whether to perform the reference mark measurement s205 is determined by notification of the progress state of the exposure processing to the measurement station during the exposure processing in the exposure station.

More specifically, the notification is sent when the number of unprocessed exposure shots reaches a predetermined number, and when the notification is received by the measurement station, if the measurement station has completed the measurement processing and is in the waiting time s204, the reference mark measurement s205 is performed. In this way, only when there is sufficient time to perform the reference mark measurement, the reference mark measurement can be performed again.

The determination method whether to perform the reference mark measurement s205 is not limited to the above method. The present invention does not limit the method to a method in which the notification is sent from the exposure station to the measurement station, but the notification may be sent from the measurement station to the exposure station.

In this case, after the focus mapping s203 is completed, the notification is sent from the measurement station to the exposure station, and thereafter the progress state of the exposure processing in the exposure station is sent to the measurement station. In this way, only when there is sufficient time to perform the reference mark measurement, the reference mark measurement can be performed again.

Next, the determination method of the stage reference mark measurement value using the reference mark measurements s201 and s205, and the advantages of the present exemplary embodiment will be described.

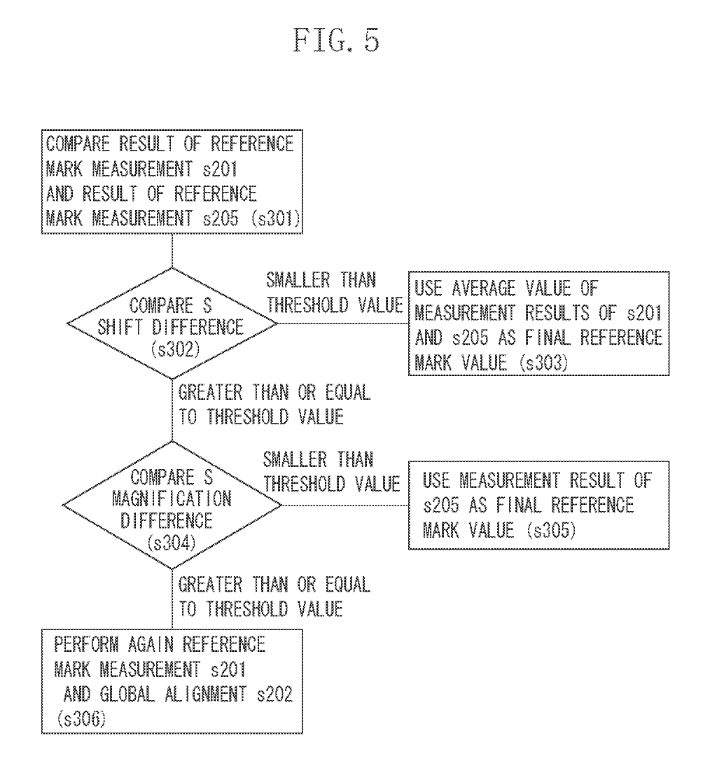

FIG. 5 illustrates a stage reference mark measurement value determination flow using the reference mark measurements s201 and s205. Generally, the reference mark measurement is performed in a plurality of left/right points on the stage, and “shift component on the stage (hereinafter, S shift)” and “magnification component on the stage (hereinafter, S magnification)” are calculated.

First, in s301, an S shift difference and an S magnification difference between the reference mark measurements s201 and s205 are calculated. When the S shift difference is smaller than a predetermined threshold value (s303), the time-dependent change is determined to be small. Since the measurement accuracy can be improved by increasing the number of measurement points, an average value of the reference mark measurements s201 and s205 is defined as the stage reference mark measurement value as the final measurement value. In this way, the accuracy of the reference mark measurement improves.

Next, when the S shift difference is greater than or equal to the threshold value and the S magnification difference is smaller than the threshold value (s305), the time-dependent change of S shift occurs, so that the latest reference mark measurement s205 is used as the stage reference mark measurement value as the final measurement value. In this way, the influence of the time-dependent change decreases.

Next, when the S shift difference is greater than or equal to the threshold value and the S magnification difference is also greater than or equal the threshold value (s306), the time-dependent change of the stage shape is large, so that it is expected that the reliability of the global alignment s202 performed in the measurement station has decreased. Therefore, the processing from s201 to s203 in the measurement station is performed again to retry the measurement having a less reliable result.

In this way, even when an abnormal state occurs in the measurement station, and the accuracy of the wafer alignment significantly decreases, the abnormal state can be detected and re-measurement can be performed. Information of the stage reference mark measurement value determined in the above described way is sent to the exposure station, and the exposure of the substrate is performed.

The sequences of the processing in the flowcharts illustrated in FIGS. 3 and 4 are not limited to the sequences illustrated in the present exemplary embodiment. The determination method of the reference mark measurement result illustrated in FIG. 5 is not limited to the S shift and the S magnification, but other components such as a rotational component of the stage may be used as an index. The determination flow of the stage reference mark measurement value according to the present exemplary embodiment is not limited to the flowchart illustrated in FIG. 5.

Although, in the first exemplary embodiment, the re-measurement of the reference mark measurement is performed only once, the reference mark measurement can be further performed if the notification is received again from the exposure station after the re-measurement of the reference mark measurement is performed. In this way, re-measurement of the reference mark measurement is performed not only once but also a plurality of times.

Next, a second exemplary embodiment will be described. The second exemplary embodiment is an exemplary embodiment of the present invention to which a process to perform the reference mark measurement a plurality of times in the exposure station is applied when the processing time of the exposure station is shorter than the processing time of the measurement station and the waiting time occurs in the exposure station.

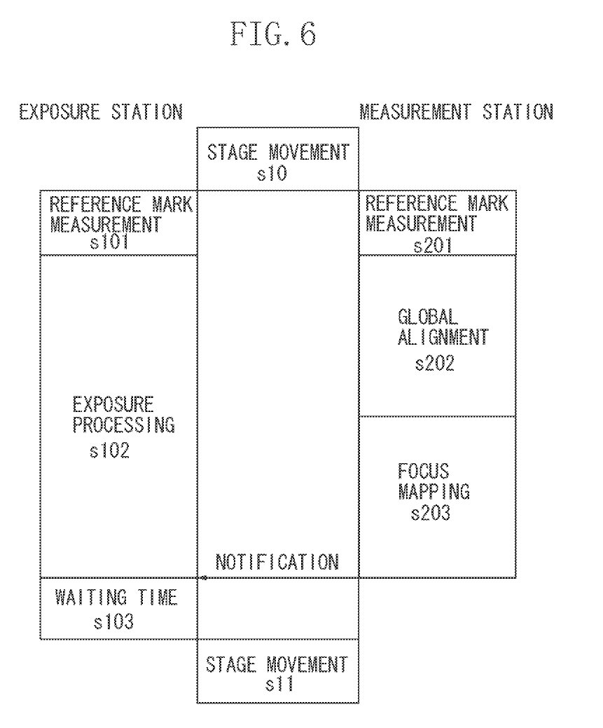

FIG. 6 illustrates a flowchart in which the waiting time occurs in the exposure station. The processing in each station is similar to that in FIG. 3, and the waiting time s103 occurs in the exposure station. Whether the waiting time s103 occurs in the exposure station is determined by the notification from the measurement station according to a processing status.

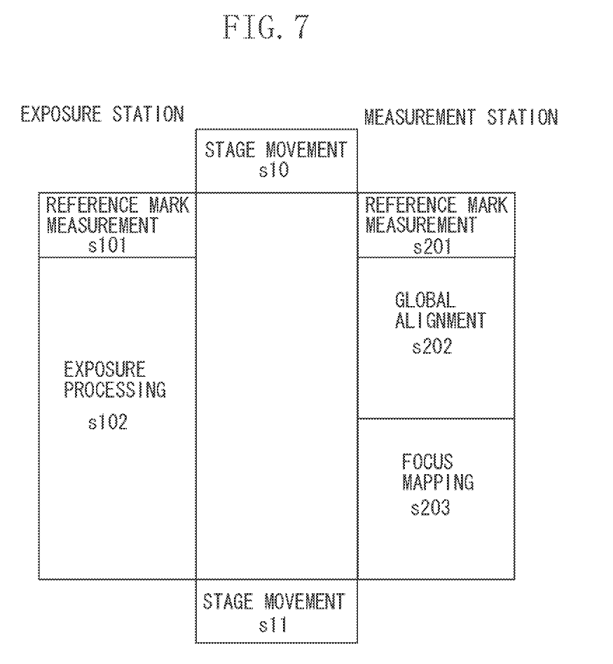

FIG. 7 illustrates a flowchart of the present exemplary embodiment. The number of measurement times of the reference mark measurement s101 in the exposure station is increased according to the waiting time s103 that occurs in FIG. 6. More specifically, the timing chart of FIG. 6 is measured in the first wafer of a process lot, and the flowchart of FIG. 7 is used for the second and following wafers.

By performing the reference mark measurement a plurality of times, the positional accuracy of the wafer on the exposure station improves compared with the case in which the reference mark measurement is not performed a plurality of times. In the present exemplary embodiment, when a waiting time occurs in the exposure station, the accuracy of the reference mark measurement can be improved without decreasing throughput.

Next, a third exemplary embodiment will be described. The third exemplary embodiment is an exemplary embodiment of the present invention to which a process to correct the stage reference mark measurement value according to elapsed time by storing a relationship between the difference between the stage reference mark measurement value and the actual position of the reference mark and the elapsed time in advance in the exposure apparatus is applied.

By using the flowchart in FIG. 4 described in the first exemplary embodiment, the influence of the time-dependent change between the stage reference mark measurement value and the re-measured stage reference mark measurement value can be decreased. However, when higher alignment accuracy is required, the time change from the stage movement s11 after the processing in each station to the reference mark measurement s101 in the exposure station may be a problem.

In this case, by measuring an amount of the time change between the stage reference mark measurement value and the actual position of the reference mark according to elapsed time, and transforming the relationship between the amount of the time-dependent change and the elapsed time into a table and storing the table in the exposure apparatus, it is possible to correct the amount of the time-dependent change between the stage reference mark measurement value and the actual position of the reference mark, which is generated while the stage is moved.

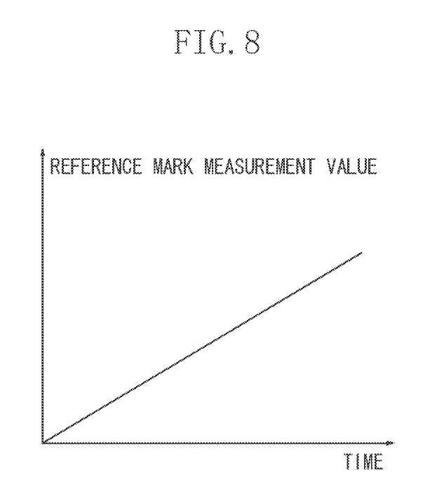

FIG. 8 illustrates an example of a graph into which the relationship between the difference between the stage reference mark measurement value and the actual position of the reference mark and time is transformed. In the present exemplary embodiment, it is possible to realize a high accuracy alignment in which an influence of a subtle time-dependent change in the stage reference mark is eliminated.

The calculation method of the relationship between the difference between the stage reference mark measurement value and the actual position of the reference mark and the elapsed time is not limited to the method of the present exemplary embodiment, but only an amount of change between before and after the stage movement may be stored. The flowchart in the present exemplary embodiment is not limited to FIG. 4, but maybe applied even when a waiting time does not occur in the measurement station and the exposure station.

Next, a method of manufacturing a device (semiconductor device, liquid crystal display device, etc.) as an embodiment of the present invention is described.

The semiconductor device is manufactured through a front-end process in which an integrated circuit is formed on a substrate such as a wafer, and a back-end process in which a product such as an integrated circuit chip is completed from the integrated circuit on the wafer formed in the front-end process. The front-end process includes a step of exposing the substrate coated with a photoresist to light using the above-described exposure apparatus of the present invention, and a step of developing the exposed substrate. The back-end process includes an assembly step (dicing and bonding), and a packaging step (sealing).

The liquid crystal display device is manufactured through a process in which a transparent electrode is formed. The process of forming a plurality of transparent electrodes includes a step f coating a substrate such as a glass substrate with a transparent conductive film deposited thereon with a photoresist, a step of exposing the substrate coated with the photoresist thereon to light using the above-described exposure apparatus, and a step of developing the exposed glass substrate.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-111122 filed Apr. 30, 2009, which is hereby incorporated by reference herein in its entirety.

What is claimed is:

1. An apparatus comprising:
a measurement station configured to perform a measurement including a reference mark measurement in which a position of a reference mark provided on a stage supporting a substrate is measured, an alignment measurement, and a focus measurement; and
an exposure station configured to perform exposure of the substrate using a result of the measurement,
wherein the exposure apparatus performs the measurement of (N+1)th substrate in parallel with exposure of the Nth substrate wherein N is a natural number, and
wherein, when time taken to perform the exposure of the Nth substrate is longer than time taken to perform the measurement of (N+1) th substrate in parallel with the exposure, the apparatus performs again the reference mark measurement.

2. The apparatus according to claim 1,
wherein during the exposure, notification is sent from the exposure station to the measurement station, and when the measurement is completed, the reference mark measurement is performed in response to the sent notification.

3. The apparatus according to claim 1,
wherein a stage reference mark measurement value is determined using a plurality of results obtained by the reference mark measurement performed a plurality of times.

4. The apparatus according to claim 3,
wherein in a process for determining the stage reference mark measurement value, when a shift difference, which is obtained from the plurality of results, is smaller than or equal to a predetermined threshold value, an average value of the results of the reference mark measurement performed a plurality of times is used as the stage reference mark measurement value,
when the shift difference is greater than or equal to the predetermined threshold value and an amount of change in magnification of the result, which is obtained from the plurality of results, is smaller than or equal to the predetermined threshold value, a result of a latest reference mark measurement is used as the stage reference mark measurement value, and
when the shift difference is greater than or equal to the predetermined threshold value and the amount of change in magnification is greater than or equal to the predetermined threshold value, the measurement by the measurement station is performed again.

5. The apparatus according to claim 3,
wherein in a process for determining the stage reference mark measurement value, the result of the reference mark measurement is corrected from a relationship between the plurality of results.

6. The apparatus according to claim 5,
wherein the relationship between the result of the reference mark measurement and time is measured in advance as an amount of a time-dependent change, and the amount of the time-dependent change is stored in the apparatus.

7. An apparatus comprising:
a measurement station configured to perform a measurement including a reference mark measurement in which a position of a reference mark provided on a stage supporting a substrate is measured, an alignment measurement, and a focus measurement; and
an exposure station configured to perform exposure of the substrate using a result of the measurement in the measurement station,
wherein the apparatus performs the measurement of (N+1)th substrate in parallel with exposure of the Nth substrate, wherein N is a natural number, and
when time taken to perform the exposure of the Nth substrate is shorter than time taken to perform the measurement of (N+1)th substrate in parallel with the exposure, the apparatus performs the reference mark measurement on the (N+1)th substrate a plurality of times.

8. The apparatus according to claim 7,
wherein when the apparatus performs the reference mark measurement by the measurement station on the (N+1)th substrate a plurality of times, the apparatus also performs the reference mark measurement by the exposure station on the (N+2)th and following substrates a plurality of times.

9. A method using an apparatus including a measurement station configured to perform a measurement including a reference mark measurement in which a position of a reference mark provided on a stage supporting a substrate is measured, an alignment measurement, and a focus measurement, and an exposure station configured to perform exposure of the substrate by using a result of the measurement, the method comprising:
performing exposure of the Nth substrate wherein N is a natural number, and
performing the measurement of (N+1)th substrate in parallel with the exposure,
wherein when time taken to perform the exposure is longer than time taken to perform the measurement in parallel with the exposure, the reference mark measurement is performed again.

10. A method using an apparatus including a measurement station configured to perform a measurement including a reference mark measurement in which a position of a reference mark provided on a stage supporting a substrate is measured, an alignment measurement, and a focus measurement, and an exposure station configured to perform exposure of the substrate by using a result of the measurement, the method comprising:
performing exposure of an Nth substrate wherein N is a natural number, and
performing the measurement of (N+1)th substrate in parallel with the exposure,
wherein when time taken to perform the measurement is longer than time taken to perform the exposure in parallel with the measurement, the reference mark measurement is performed a plurality of times.

11. A method by using an apparatus including a measurement station configured to perform a measurement including a reference mark measurement in which a position of a reference mark provided on a stage supporting a substrate is measured, an alignment measurement, and a focus measurement, and an exposure station configured to perform exposure of the substrate by using a result of the measurement, wherein the apparatus performs the measurement of (N+1)th substrate in parallel with exposure of the Nth substrate wherein N is a natural number, and wherein, when time taken to perform the exposure of the Nth substrate is longer than time taken to perform the measurement of (N+1)th substrate in parallel with the exposure, the apparatus performs again the reference mark measurement, the method comprising:
exposing the substrate; and
developing the substrate.

12. A method by using an apparatus including a measurement station configured to perform a measurement including a reference mark measurement in which a position of a reference mark provided on a stage supporting a substrate is measured, an alignment measurement, and a focus measurement, and an exposure station configured to perform exposure of the substrate by using a result of the measurement, wherein the apparatus performs the measurement of (N+1)th substrate in parallel with exposure of the Nth substrate, wherein N is a natural number, and when time taken to perform the exposure of the Nth substrate is shorter than time taken to perform the measurement of (N+1) th substrate in parallel with the exposure, the apparatus performs the reference mark measurement on the (N+1)th substrate a plurality of times, the method comprising:
exposing a substrate; and
developing the substrate.

13. The method according to claim 9, further comprising
during the performing exposure, sending notification; and
when the performing the measurement is completed, performing the reference mark measurement in response to the sending notification.

14. The method according to claim 9, further comprising:
determining a stage reference mark measurement value using a plurality of results obtained by performing the reference mark measurement a plurality of times.

15. The method according to claim 14, wherein in a process for determining the stage reference mark measurement value, the result of the reference mark measurement is corrected from a relationship between the plurality of results.

16. The method according to claim 15, wherein the relationship between the result of the reference mark measurement and time is measured in advance as an amount of a time-dependent change, and the amount of the time-dependent change is stored in the apparatus.

17. The method according to claim 10, further comprising
during the performing exposure, sending notification; and
when the performing the measurement is completed, performing the reference mark measurement in response to the sending notification.

18. The method according to claim 10, further comprising:
determining a stage reference mark measurement value using a plurality of results obtained by performing the reference mark measurement a plurality of times.

19. The method according to claim 18, wherein in a process for determining the stage reference mark measurement value, the result of the reference mark measurement is corrected from a relationship between the plurality of results.

20. The method according to claim 19, wherein the relationship between the result of the reference mark measurement and time is measured in advance as an amount of a time-dependent change, and the amount of the time-dependent change is stored in the apparatus.
